(19) United States
(12) Patent Application Publication
(10) Pub. No.: US 2012/0014578 A1
(43) Pub. Date: Jan. 19, 2012

(54) Computer Aided Detection Of Abnormalities In Volumetric Breast Ultrasound Scans And User Interface

(75) Inventors: Nico Karssemeijer, Beek-Ubbergen (NL); Wei Zhang, Union City, CA (US)

(73) Assignee: QView Medical, Inc., Los Altos, CA (US)

(21) Appl. No.: 12/839,371

(22) Filed: Jul. 19, 2010

(51) Int. Cl. G06K 9/00

(52) U.S. Cl. 382/131

(57) ABSTRACT

Methods and related systems are described for detection of breast cancer in 3D ultrasound imaging data. Volumetric ultrasound images are obtained by an automated breast ultrasound scanning (ABUS) device. In ABUS images breast cancers appear as dark lesions. When viewed in transversal and sagittal planes, lesions and normal tissue appear similar as in traditional 2D ultrasound. However, architectural distortion and spiculation are frequently seen in the coronal views, and these are strong indicators of the presence of cancer. The described computerized detection (CAD) system combines a dark lesion detector operating in 3D with a detector for spiculation and architectural distortion operating on 2D coronal slices. In this way a sensitive detection method is obtained. Techniques are also described for correlating regions of interest in ultrasound images from different scans such in different scans of the same breast, scans of a patient's right versus left breast, and scans taken at different times. Techniques are also described for correlating regions of interest in ultrasound images and mammography images. Interactive user interfaces are also described for displaying CAD results and for displaying corresponding locations on different images.

### BACKGROUND

1. Field

This patent specification relates to medical imaging systems and processes. In particular, the present invention relates to the computer aided detection of breast abnormalities in volumetric breast ultrasound scans, and devices and methods of interactive display of such computer aided detection results.

2. Related Art

Breast cancer screening programs currently use x-ray mammography to find cancers in an early stage when treatment is most effective. However, in dense breasts mammography is known to be insensitive. Therefore, new screening modalities are being investigated that may complement or replace mammography in women with high breast density. The most promising new technologies for screening dense breasts are dynamic contrast enhanced MRI, and automated breast ultrasound scanning. The latter technique is less sensitive than MRI, but has the advantage that it is relatively inexpensive that it does not require the use of a contrast agent. The use of gadolinium in contrast agent enhanced MRI may not be acceptable in a screening population. Effectiveness of handheld breast ultrasound screening has been demonstrated in several trials. See, Kolb T M, Lichy J, Newhouse J H: Comparison of the performance of screening mammography, physical examination, and breast US and evaluation of factors that influence them: An analysis of 27,825 patient evaluations. Radiology (2002); 225(1): 165-75; and Berg W A, et al., Combined Screening With Ultrasound and Mammography vs. Mammography Alone in Women at Elevated Risk of Breast Cancer. JAMA, May 14, 2008; 299: 2151-2163 (2008). However, the fact that this screening exam, requiring radiologists to perform by hand and read the images as being generated, is time consuming for radiologists makes it less attractive. This is being somewhat alleviated however, with volumetric ultrasound images obtained by an automated breast ultrasound scanning (ABUS) technology. Typically an ABUS device is used to image a whole breast volume with up to three partially overlapping scans per breast, which would generate several hundred images or slices. Although the image acquisition with ABUS can generally be performed by technicians, radiologists are still required to read the hundreds of images, thus breast imaging with ABUS can still be relatively time consuming. A complete screening exam consists of hundreds of images or slices, and the information content of each of the images is high. Abnormalities can therefore be easily overlooked when the images are being inspected slice by slice.

There have been publications on development of computer aided diagnosis in ultrasound. The majority deals with traditional 2D handheld ultrasound and aim at helping the radiologist to diagnose lesions. In these papers, the detection of a lesion refers to an automatic segmentation of lesions in a 2D image selected by the radiologist. As the radiologist determines the target lesion, it is usually located in the center of the image. After segmentation of the lesion, features are extracted and a classifier is trained to distinguish benign and malignant lesions. See, Drukker, K.; Giger, M. L.; Horsch, K.; Kupinski, M. A.; Vyborny, C. J. & Mendelson, E. B. “Computerized lesion detection on breast ultrasound,” Med Phys, 2002, 29, 1438-1446; Drukker and M. L. Giger, “Computerized analysis of shadowing on breast ultrasound for improved lesion detection,” Med. Phys. 30, 1833-1842 (2003); K. Horsch, M. L. Giger, C. J. Vyborny, and L. A. Venta, “Performance of computer-aided diagnosis in the interpretation of lesions on breast sonography,” Acad. Radiol. 11, 272-280 (2004); V. Mogatadakala, K. D. Donohue, C. W. Piccoli, and F. Forsberg, “Detection of breast lesion regions in ultrasound images using wavelets and order statistics,” Med. Phys. 33, 840-849 (2006); and Drukker, C. A. Sennett, and M. L. Giger, “Automated method for improving system performance of computer-aided diagnosis in breast ultrasound,” IEEE Trans. Med. Imaging 28, 122-128 (2009).

Characterisation of breast lesions in 3D ultrasound has been explored. See, Sahiner, B.; Chan, H.-P.; Roubidoux, M. A.; Helvie, M. A.; Hadjiiski, L. M.; Ramachandran, A.; Paramagul, C.; LeCarpentier, G. L.; Nees, A. & Blane, C, “Computerized characterization of breast masses on three-dimensional ultrasound volumes,” Med Phys, 2004, 31, 744-754; Sahiner, B.; Chan, H.-P.; Roubidoux, M. A.; Hadjiiski, L. M.; Helvie, M. A.; Paramagul, C.; Bailey, J.; Nees, A. V. & Blane, C, “Malignant and benign breast masses on 3D US volumetric images: effect of computer-aided diagnosis on radiologist accuracy,” Radiology, 2007, 242, 716-724; Sahiner, B.; Chan, H.-P.; Hadjiiski, L. M.; Roubidoux, M. A.; Paramagul, C.; Bailey, J. E.; Nees, A. V.; Blane, C. E.; Adler, D. D.; Patterson, S. K.; Klein, K. A.; Pinsky, R. W. & Helvie, M. A, “Multi-modality CADx: ROC study of the effect on radiologists' accuracy in characterizing breast masses on mammograms and 3D ultrasound images,” Acad Radiol, 2009, 16, 810-818; and Cui, J.; Sahiner, B.; Chan, H.-P.; Nees, A.; Paramagul, C.; Hadjiiski, L. M.; Zhou, C. & Shi, J; “A new automated method for the segmentation and characterization of breast masses on ultrasound images,” Med Phys, 2009, 36, 1553-1565. This work is based on images from a targeted 3D ultrasound scanning system. Only a small volume holding the lesion is imaged and analyzed. The purpose is distinguishing benign and malignant lesions. Features used in the work above include morphology (e.g. height to width ration), posterior acoustic shadowing, lesion and margin contrast.

Computer aided detection in whole breast ultrasound with the aim of assisting in screening has been described in a few publications. See, Ikedo, D. Fukouka, T. Hara, H. Fujita, E. Takada, T. Endo, and T. Morita, “Development of a fully automatic scheme for detection of masses in whole breast ultrasound images,” Med. Phys. 34, 4378-4388 (2007); and Chang R et al. “Rapid image stitching and computer-aided detection for multipass automated breast ultrasound,” Med. Phys. 37 (5) 2010. This work describes a method in which serial 2D images are analyzed separately by the CAD system.

U.S. Pat. No. 7,556,602 (hereinafter the “the '602 patent”) discusses the use of ultrasound mammography in which an automated transducer scans the patient's breast to generate images of thin slices that are processed into fewer thick slices simultaneously for rapid assessment of the breast. Computer aided detection or diagnosis can be preformed on images and resulting mark and/or other information can be displayed as well. The '602 patent discusses extracting and applying a classifier algorithm to known two-dimensional features such as spiculation metrics, density metrics, eccentricity metrics and sphericity metrics. However, spiculation is not identified or suggested as a criterion used for candidate detection (which is referred to as the ROI location algorithm). The '602 patent also discusses correlating regions of interest in an x-ray mammogram view to an adjunctive ultrasound view. However the disclosed algorithms are applicable to cases where the mammogram view and the ultrasound view are taken from the same standard view (e.g. CC or MLO) or at least where the breast tissue is compressed, in both ultrasound and mammography, in directions perpendicular to an axis that is perpendicular to the chest wall and passes through the nipple.

### SUMMARY

Accordingly, a computer aided detection method that helps radiologists in searching and interpretation of abnormalities would be very useful. According to some embodiments, a novel CAD system is provided for detection of breast cancer in volumetric ultrasound scans.

According to some embodiments, a method of analyzing ultrasound images of breast tissue is provided. The method includes receiving and processing a digitized ultrasound image of the breast tissue so as to generate a three-dimensional image composed of view slices that are approximately perpendicular to the direction of compression of the breast tissue during ultrasound scanning. The 3D image is further processed using one or more computer aided detection algorithms so as to identify locations of one or more regions of interest within the image based at least in part on identified areas of spiculation in portions of one or more of the view slices. According to some embodiments, the compression direction is towards the chest wall and the areas of spiculation are identified in portions of coronal view slices being approximately parallel to the skin surface. Features extracted from the 3D image such as based on gradient convergence, local contrast, and/or posterior shadowing can also be used to identified regions of interest in the image, in combination with spiculation. According to some embodiments, the features are computed at regularly spaced locations in the image, at each location using computations that include voxel values in a local 3D subvolume. According to some embodiments, a likelihood of malignancy for each of the regions of interest can be estimated and displaying to a user. The method can be used for screening and/or diagnostic purposes

According to some embodiments, a method of analyzing ultrasound images of breast tissue of a patient is provided that includes receiving and processing two digitized three-dimensional ultrasound images of breast tissue of the patient so as to generate a region of interest in each image. A likelihood of malignancy is then evaluated based at least in part on the estimated distance between the locations of the regions of interest in the two images. According to some embodiments, the two images can be of the same breast of the patient as in the first image, such as two offset scans of the same breast taken during the same scanning procedure, or of the same breast during a prior year screening. According to some embodiments, the two images can be the left and right breast of the patient using a reference point such as the nipple, so as to evaluate symmetry when evaluating the likelihood of malignancy.

According to some embodiments, a method of analyzing digital images of breast tissue of a patient is provided that includes receiving and processing a digitized ultrasound image of breast tissue compressed in a direction towards a chest wall using one or more computer aided detection algorithms thereby generating a region of interest in the ultrasound image; receiving and processing a digitized mammographic image, such as a CC or MLO view, of the same breast tissue using one or more computer aided detection algorithms thereby generating a region of interest in the mammographic image; and evaluating the likelihood of malignancy based at least in part on the estimated distance between a location of the region of interest in the ultrasound image and a location the region of interest in the mammographic image. According to some embodiments, the mammographic image is a tomographic mammographic image.

According to some embodiments, a method of interactively displaying ultrasound and mammographic images of breast tissue to a user is provided. The method includes receiving one or more digitized mammographic images, such as CC or MLO views, of the breast tissue, and a digitized three-dimensional ultrasound image of the breast tissue compressed in a direction towards a chest wall of the patient. The user identifies a location or locations on the one or more mammographic images of a user identified region of interest in the breast tissue. One or more locations are estimated on the ultrasound image that correspond to the location or locations on the one or more mammographic images of the user identified region of interest, and portions of the digitized ultrasound image are displayed to the user so as to indicate the one or more estimated locations corresponding to the region of interest. According to some embodiments an estimated position of the user identified region of interest relative to an identified nipple on the breast tissue is displayed to the user using a clock position and distance from the nipple. According to some embodiments, the mammographic image is a three-dimensional mammographic image. According to some embodiments, the user identified region of interest is located by the user first in the ultrasound image, then the location or locations on the mammographic image or images are estimated and displayed to the user.

According to some embodiments, a method of interactively displaying computer aided detection results of medical ultrasound images to a user is provided that includes receiving a digitized ultrasound image of breast tissue; processing the image using one or more computer aided detection algorithms thereby generating one or more regions of interest; displaying the digitized image along with one or more marks tending to indicate location on the tissue of the regions of interest and information relating to an estimated likelihood of malignancy, such as a percentage or a color indicating a percentage range, for each displayed region of interest.

According to some embodiments related systems for analyzing digital images of breast tissue, and for displaying ultrasound and mammographic images of a breast tissue to a user are provided.

Further features and advantages will become more readily apparent from the following detailed description when taken in conjunction with the accompanying drawings.

### BRIEF DESCRIPTION OF THE DRAWINGS

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 is a flow chart illustrating the detection method according to some embodiments;

FIGS. 2A-C are examples of a cross section through a malignant lesion showing features identified according to some embodiments;

FIG. 3 is a flowchart showing combination of features at a voxel level using context, resulting in a likelihood of abnormality, according to some embodiments;

FIG. 4 is a matrix of coronal views and cross sections of a malignant lesion at three different depths, according to some embodiments;

FIG. 5 illustrates methods of presenting CAD results to users, according to some embodiments;

FIG. 6 is a plot showing detection sensitivity as a function of the number of false positives per 3D image volume, according to some embodiments;

FIG. 7 is a flowchart showing steps in carrying out CAD analysis of ultrasound breast images, according to some embodiments;

FIGS. 8A-C show further detail of view correlation procedures, according to some embodiments;

FIGS. 9A-B show further detail of left and right symmetry checking, according to some embodiments;

FIGS. 10A-B show further detail of temporal correlation procedures, according to some embodiments;

FIGS. 11A-C show further detail of correlation procedures between ultrasound images and cranio-caudal (CC) view of a mammographic image, according to some embodiments;

FIGS. 12A-C show further detail of correlation procedures between ultrasound images and mediolateral oblique (MLO) view of a mammographic image, according to some embodiments;

FIG. 13 shows a user interface which relates positions in mammographic and ultrasound images, according to some embodiments; and

FIGS. 14A-D show x-ray tomosynthesis imaging displayed views, according to some embodiments.

### DETAILED DESCRIPTION OF THE PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

According to some embodiments, a system is described for detection of breast cancer in 3D ultrasound imaging data. Volumetric ultrasound images are obtained by an automated breast ultrasound scanning (ABUS) device. Typically this device is used to image a whole breast volume with up to three partially overlapping scans. Breast cancer screening with ABUS is time consuming as up to six scans per patient (three per breast) have to be read slice by slice. By using effective computer aided detection methods feasibility of breast cancer screening with ABUS may be increased.

In ABUS images breast cancers appear as dark lesions. When viewed in transversal and sagital planes, lesions and normal tissue appear similar as in traditional 2D ultrasound. However, when viewing ABUS images in coronal planes (in parallel to the skin surface) images look remarkably different. In particular, it appears that architectural distortion and spiculation are frequently seen in the coronal views, and these are strong indicators of the presence of cancer. Therefore, in the computer aided detection (CAD) system according to some embodiments, combine a dark lesion detector operating in 3D is combined with a detector for spiculation and architectural distortion operating on 2D coronal slices. In this way a sensitive detection method is obtained.

To effectively use the CAD system to guide search and interpretation in 3D breast ultrasound screening a new system for presenting CAD information is presented as well, based on coronal viewing and interactive CAD marker projections.

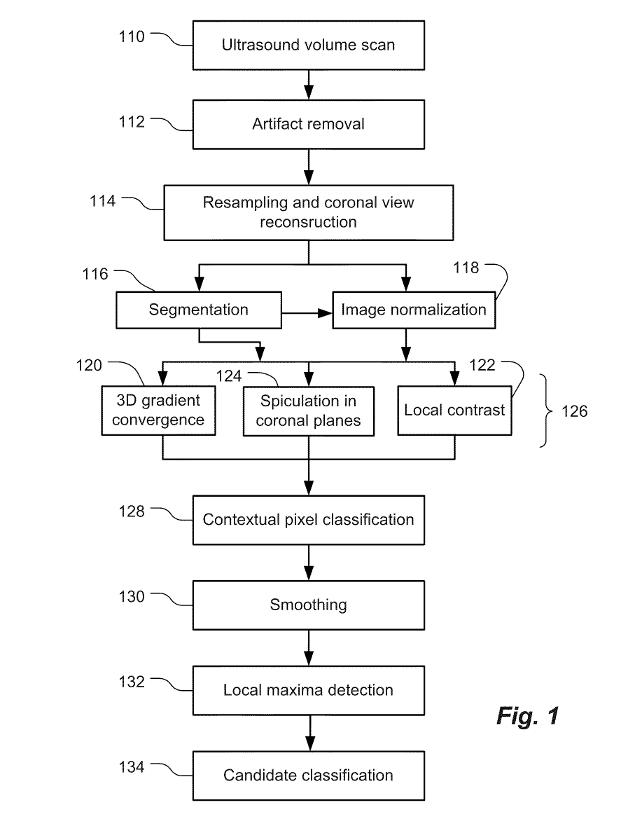

Image segmentation and normalization. FIG. 1 is a flow chart illustrating the detection method according to some embodiments. First, image data 110 from the scanning device is converted to a coronal representation. This comprises (1) artifact removal (step 112), (2) re-sampling of the data to isotropic resolution (step 114), and (3) rotation of the data to coronal orientation (step 114). Artifact removal, step 112, addresses correction of scan line artifacts due to signal transfer variation during scanning. Lines with an outlying mean value are corrected using the mean value of neighboring lines as a reference. In the resampling step 114, the image data is converted to cubic voxels of 0.5 mm. In coronal views the (x,y) planes hold coronal slices, which are in parallel to the skin surface during scanning, while the z coordinate represents depth.

In step 116, the image volume is segmented in four classes: background, fatty breast tissue, dense breast tissue, and other tissue. First, the background is labelled using feature based voxel classification and morphological operators. Features include texture and voxel value. If the voxel value is low and texture indicates a homogeneous neighborhood voxels are labelled as background. Next, the chest-wall is detected using dynamic programming in transversal and sagittal slices, and by subsequently fitting a parameterized surface through the set of obtained boundary points. Voxels between the chest wall and skin are labelled as breast tissue. Using Otsu's method a threshold is determined to label fatty and dense tissue voxels in the breast.

Before further processing, images voxel values are normalized in step 118, using the segmented breast tissue volume. From the labelled image, mean values of voxels labelled as dense and fatty tissue are computed. These are denoted by mean_fat and mean_dense respectively. Using the mean values, contrast of the image is normalized by:

y=y_fat+constant*(y_original−mean_fat)/(mean_dense−mean_fat)

with y_original being the voxel value before normalization, and y and y_fat the voxel value and the mean voxel value of fatty tissue after contrast normalization.

Voxel feature extraction takes place using modules 126. After normalization, the breast tissue region is processed to extract local features. Three modules are used, each targeting a different characteristic of breast cancers in ultrasound. Cancers appear as dark regions with relatively compact shapes. The mean voxel value in malignant lesions is lower than that the surrounding fatty tissue, and often a dark shadow is present under the lesion. Finally, in coronal slices through, or near, malignant lesions spiculation or architectural distortion is often visible. This a new radiological sign, which is not observed in traditional hand-held ultrasound because this modality was not able to show the coronal plane. The three modules 126 are developed to capture the characteristic features and are described below.

The first module 120 computes volumetric gradient convergence features that give a high response at the center of compact regions. It operates on the 3D gradient vector field derived from the image at a chosen scale. The module computes the number of gradient vectors directed to the center of a spherical neighborhood covered by the filter. This number is normalized by subtracting its expected value and by dividing the result by its standard deviation, both determined for a reference pattern of random gradient directions. At any given location, the filter output is obtained as a function of the neighborhood radius R, making the filter equally responsive to both small and large lesions. At each location the maximum filter output and corresponding neighborhood size are determined. Apart from the integrated measure of convergence, also the isotropy of convergence is determined. For further detail of this method applied in a 2D application, See: Brake, G. M. & Karssemeijer, N. (1999), “Single and multiscale detection of masses in digital mammograms,” IEEE Transactions on Medical Imaging. Vol. 18(7), pp. 628-639; Karssemeijer, N. & to Brake, G. M., “Detection of stellate distortions in mammograms,” IEEE Transactions on Medical Imaging. Vol. 15(5), pp. 611-619 (1996) (hereinafter “Karssemeijer (1996)”); and Karssemeijer, N., “Local orientation distribution as a function of spatial scale for detection of masses in mammograms,” Information Processing in Medical Imaging, LNCS 2082 (Springer), pp. 280-293 (1999) (hereinafter “Karssemeijer (1999)”).

According to some embodiments, analysis of local line and gradient direction patterns forms the basis for computation of the local features that are used. Further detail of this method will now be described. According to some embodiments, the size of the neighborhood in which orientations patterns are evaluated is one of the most important parameters in the computation of these features. Variation of this size can have a dramatic effect on the detection of individual cancers, although the influence of this parameter on the overall performance measured on a large database tends to be less. In the past, the output of a local contrast operator has been used to set the size of the neighborhood adaptively. In the method presented herein features are computed as a continuous function of the neighborhood size, only slightly increasing the computational load. The method is described here for 2D application, but can be used in higher dimensions as well.

Local orientation distributions. It has been shown that features representing local orientation distributions are well suited for detection of masses in mammograms. See, N. Karssemeijer, “Detection of stellate distortions in mammograms using scale space operators,” In Y Bizais, C Barrilot, and R Di Paola, editors, Information Processing in Medical Imaging, pages 335-346. Kluwer, Dordrecht, 1995; Karssemeijer (1996); and G M to Brake and N Karssemeijer, “Detection of stellate breast abnormalities,” In K Doi, M L Giger, R M Nishikawa, and R A Schmidt, editors, Digital Mammography, pages 341-346. Elsevier, Amsterdam, 1996 (hereinafter “te Brake (1996)”). The fact that such features are very insensitive to changes in contrast is a major advantage when processing large datasets of images of various origin, because one has to deal with unknown non-linear variation of the greyscale. Orientation maps are computed using first and second order Gaussian derivatives. When there is a concentration of gradient orientation towards a certain point this indicates the presence of a mass. A concentration of line orientations computed from second order directional derivatives indicates the presence of spiculation or architectural distortion. These concentration or convergence features will be denoted by g1 and l1, respectively for gradient and line orientations. In addition, features representing radial uniformity measure whether or not increase of pixels oriented to a center comes from the whole surrounding area or from a few directions only. These will be denoted by g2 and l2.

In Karssemeijer (1996), features for orientation concentration were computed by counting the number of pixels pointing to a center, and were defined to measure deviations of this number from the expected value in a random orientation pattern. The assumption was made that a binomial distribution of this number with mean probability p̅ of a pixel pointing to a center can be used for normalization. As the probability p of hitting the center varies with the distance, this normalization may not be best choice. A more general definition of the features was given in Karssemeijer (1999), which discusses how to deal with varying values ofp properly. Note that the papers referred to above present the method for the 2D case and has applied to the techniques described herein they are extended to 3D.

For computation of the features at a given voxel i a circular neighborhood is used in the 2D case and a spherical neighbourhood in the 3D case. The term voxel is used for image samples in both the 2D and 3D case. All voxels j located within a distance rₘᵢₙ<rᵢⱼ<rₘₐₓ from i are selected when the magnitude of the orientation operator exceeds a small threshold. This selected set of voxels is denoted by Sᵢ. The features are based on a statistic xⱼ defined by

$${x}_{j} = \{ \begin{matrix}1 - {p}_{j} & if pixel j oriented to center \\ - {p}_{j} & else\end{matrix} \qquad ( 1 )$$

with pⱼ the probability that voxel j is oriented towards the center given a random pattern of orientations. Voxels that are oriented to the center can be determined by evaluating:

arc cos(v·r)<D/(2rᵢⱼ) (2)

with r the unit vector in the direction from j to i, v a unit vector with the voxel orientation at j and D a constant determining the accuracy with which voxels should be directed to the center to be counted. Alternative ways of determining when a voxel is oriented to the center can also be used. In the application presented here we use the equation above for mass detection, where voxel orientations are 3D gradient vectors. However, we use arc cos (|v·r|)<D/(2rᵢⱼ) for spiculation detection, because in that case the pixel orientations are 2D line orientation estimates. After computing xⱼ for voxels in the neighborhood of i weighted sum Xᵢ is computed by

$${X}_{i} = {\sum }_{j ∈ {S}_{i}} {w}_{j} {x}_{j} \qquad ( 3 )$$

where the weight factors can be chosen as a function of the distance rᵢⱼ, for instance to give voxels closer to the center a larger weight. For a noise pattern, the variance of this sum can be estimated when it is assumed that all voxel contributions are independent:

$$\begin{matrix}var ( {X}_{i} ) = var ( {\sum }_{j ∈ {S}_{i}} {w}_{j} {x}_{j} ) \\ = {\sum }_{j ∈ {S}_{i}} {w}_{j}^{2} var ( {x}_{j} ) \\ = {\sum }_{j ∈ {S}_{i}} {w}_{j}^{2} {p}_{j} ( 1 - {p}_{j} )\end{matrix} \qquad ( 4 )$$

Normalizing the sum Xᵢ by the square root of the variance the value of the concentration feature f₁ is defined by

$${f}_{1} = \frac{{\sum }_{j ∈ {S}_{i}} {w}_{j} {x}_{j}}{{( {\sum }_{j ∈ {S}_{i}} {w}_{j}^{2} {p}_{j} ( 1 - {p}_{j} ) )}^{\frac{1}{2}}} \qquad ( 5 )$$

When no weight factors are used and the neighborhood Sᵢ is subdivided in K rings (or spherical shells in 3D) around i in which the probability pₖ can be considered constant, the sum Xᵢ can be written as

$${X}_{i} = {\sum }_{k} {\sum }_{j ∈ {S}_{i , k}} {x}_{j} \qquad ( 6 )$$

In each ring (or shell) k the number of voxels hitting the center N_{k, hit} can be counted, allowing the sum to be rewritten as

$$\begin{matrix}{X}_{i} = {\sum }_{k} {N}_{k , hit} ( 1 - {p}_{k} ) + ( {N}_{k} - {N}_{k , hit} ) ( - {p}_{k} ) \\ = {\sum }_{k} {N}_{k , hit} - {N}_{k} {\overline{p}}_{k} \\ = {N}_{hit} - N \overline{ p}\end{matrix} \qquad ( 7 )$$

with Nₖ and N the number of voxels in ring (shell) k and in total, respectively. The normalization factor which can be written as (N( p̅− p̅²̅))^{-1/2}.

If weight factors are used that only depend on pⱼ, the sum Xᵢ can be written as

$${X}_{i} = {\sum }_{k} {w}_{k} [ {N}_{k , hit} - {N}_{k} \overline{{p}_{k}} ] \qquad ( 8 )$$

the expected value of f₁ remains zero.

It is noted that the approximation that is made by assuming all voxels to have independent directions is clearly incorrect, even when voxels have independent random values. Orientations of neighboring voxels become correlated by the use of convolution kernels for estimation. This leads to underestimation of the variance, which becomes larger with larger kernels. However, it seems that this effect is similar for normal and abnormal areas. For the purpose of removing dependency of the size of the neighborhood and compensating unwanted effects at the breast edge boundary the method is effective.

Features g2 and l2 that measure radial uniformity of the orientation patterns around site i are computed by subdividing the neighborhood Sᵢ in L directional bins, that is like a pie. The statistic Xᵢ is computed now for each bin. When there is only noise the expected value of Xᵢ in each bin is zero. In previous work, the number of bins was counted in which the number of voxels pointing to the center was larger than the median of a binomial distribution determined by Nₗ and p̅, with Nₗ and p̅ₗ the number of voxels in bin l and p̅ₗ the average probability of hitting the center. This definition had some problems, as the median of a binomial distribution is not exactly defined. With the approach described here, it is sufficient to compute the number of bins n₊ in which the sum of X_{i,k} is positive. The radial uniformity feature is defined by

$$f 2 = \frac{{n}_{+} - {K}_{i} / 2}{\sqrt{{K}_{i} / 4}} , \qquad ( 9 )$$

with Kᵢ the number of sectors at i. The standard deviation of n₊ for random noise \sqrt{Kₗ/4} is used for normalization, which is important to avoid problems at the edge of the breast where not all sectors can be used.

Computation of features as a function of scale. In multiscale methods one tries to match the scale of feature extraction to the scale of the abnormality in order to optimize detection performance. Generally, the value of features used for mass detection depend strongly on the size of the abnormality, which makes multiscale approaches attractive. However, most multiscale methods are computationally intensive, because features have to be computed repeatedly at a number of scales. Usually only a very limited number of scales are chosen, which reduces accuracy. Multiscale methods that have been proposed for detection of masses in mammograms include: for wavelets, see, A. F. Laine, S. Schuler, J. Fan, and W. Huda, “Mammographic feature enhancement by multiscale enhancement,” IEEE Trans on Med Imag, 13:725-740, (1994); for maximum entropy, see L. Miller and N. Ramsey, “The detection of malignant masses by non-linear multiscale analysis,” In K. Doi, M. L. Giger, R. M. Nishikawa, and R. A. Schmidt, editors, Digital Mammography, pages 335-340, Elsevier, Amsterdam (1996); and for multi-resolution texture analysis, see, D. Wei, H. P. Chan, M. A. Helvie, B. Sahiner, N. Petrick, D. D. Adler, and M. M. Goodsitt, “Classification of mass and normal breast tissue on digital mammograms: multiresolution texture analysis,” Med Phys, 22:1501-1513, 9 (1995). Also line concentration measured at a number of scales was used in previous work on detection of stellate lesions, where the maximum over the scales was used Karssemeijer (1996).

According to some embodiments, a method is described that allows very efficient computation of a class of local image features as a continuous function of scale, only slightly increasing the computational effort needed for computation at the largest scale considered. The non-linear features described in the previous subsection belong to this class. In the first step of the algorithm an ordered list is constructed in which each element represents a neighbor j within distance rᵢⱼ of the central location i. In this list, positional information of the neighbor that is needed for the computation is stored, here the xⱼ, yⱼ offset, orientation and distance rᵢⱼ with respect to center. This list is constructed by visiting all voxels in any order, and by subsequently sorting its elements by distance to the center. In the second step the actual computation of the features takes place, at each voxel or at a given fraction of voxels using a sampling scheme. The ordered list of neighbors is used to collect the data from the neighborhood. The xⱼ, yⱼ offsets in the list are used to address the voxel data and precomputed derivatives or orientations at the location of the neighbor. The orientation with respect to i is used to compute orientation related features. Because the neighbors are ordered with increasing distance to the center, computation of the features from the collected data can be carried out at given intervals, for instance each time the number of neighbors has increased by some fixed number. As the computational effort lies in collection of the data, this only slightly increases the computational load. We use intervals in which the number of neighbors increases quadratically for 2D and with a power of three for 3D. Thus, features are computed at regularly spaced distances from the center. In a similar way, a contrast feature can be computed by collecting the sum of voxel values as a function of distance to the center, and by and subtracting the mean of the last interval from the mean of the previous intervals. The curves that represent features as a function of the distance to the center reveal aspects of the neighborhood patterns that can be useful for differentiation of true and false positive detections.

Referring again to FIG. 1, module 124 is designed to find spiculation or architectural distortion in coronal planes, using the method above in 2D. In contrast to module 120, where gradient vectors are used, in this module 124 a line orientation pattern forms the basis for feature computation. Line orientations are obtained using a basis of second order Gaussian directional derivatives. By applying the method to each coronal slice independently, a response for each breast tissue voxel is obtained.

Module 122 computes local contrast as a function of scale. At each location in the image the mean voxel value m(x,y,z) in a neighborhood is computed. The neighborhood is defined by all voxels within distance R1 from the central location. Contrast is computed by subtracting this mean value from the mean value of voxels labeled as fatty tissue just outside the neighborhood, i.e. voxels with distance to the center within an interval [R1,R1+ΔR]. According to some embodiments, local contrast features are computed for various neighborhood types: (1) A spherical neighborhood with a fixed radius, (2) A spherical neighborhood with radius estimated from the image data, for instance by taking the radius at which the gradient concentration filter g1 has the highest output maximum response, (3) a semi-spherical neighborhood including only superficial voxels, i.e those that are closer to the transducer (or skin) than the central location, (4) a semi-spheric neighborhood including only deeper voxels (further away from the transducer than the central location), and (5) the spherical neighborhood with the radius that gives the highest local contrast.

In the examples discussed thus far, it is assumed that the breast tissue has been compressed towards the chest wall during the ultrasound scanning process. Note that the ROI location detection schemes described herein can also apply to other compression directions. According to some embodiments, the ultrasound images can result from breast tissue compressions in directions other than toward the chest wall. For example, the ultrasound image can result from a scan in which the breast is compressed in a direction such as with conventional mammography (e.g. as in CC and/or MLO views. In general, according to some embodiments, the module 124 is designed to find spiculations and/or architectural distortions in plans perpendicular to the direction of compression. For example, if the compression direction of the ultrasound scan is as in a CC mammography view, then the module 124 would look for spiculations and/or architectual distortions in a transverse plane.

Note that the modules 126, including spiculation module 124 are used in candidate detection (i.e. to locate the regions of interest). This is in contrast to techniques such as discussed in the '602 patent where features such as spiculation metrics are only used for classification of regions of interest.

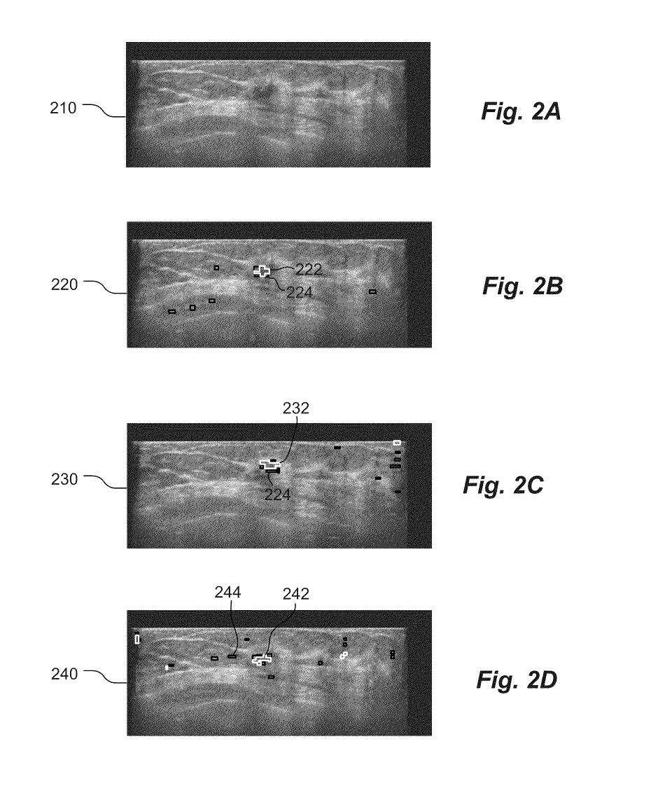

FIGS. 2A-C are examples of a cross section through a malignant lesion showing features identified according to some embodiments. The skin surface is on top in each of the views. In FIG. 2A, the original cross section image 210 is shown. FIG. 2B shows the response 220 of gradient convergence module 120 (as described with respect to FIG. 1). The highest values are shown outlined in white such as region 222, and the next highest values are shown outlined in black such as region 224. FIG. 2C shows the response 230 of coronal spiculation module 124 (as described with respect to FIG. 1). The highest values are shown outlined in white such as region 232, and the next highest values are shown outlined in black such as region 234. FIG. 2D shows the response 240 of local contrast module 122 (as described with respect to FIG. 1). The highest values are shown outlined in white such as region 242, and the next highest values are shown outlined in black such as region 244. It can be seen that the maxima of the responses are not aligned. In particular, the coronal spiculation feature is strongest in the upper part of the lesion.

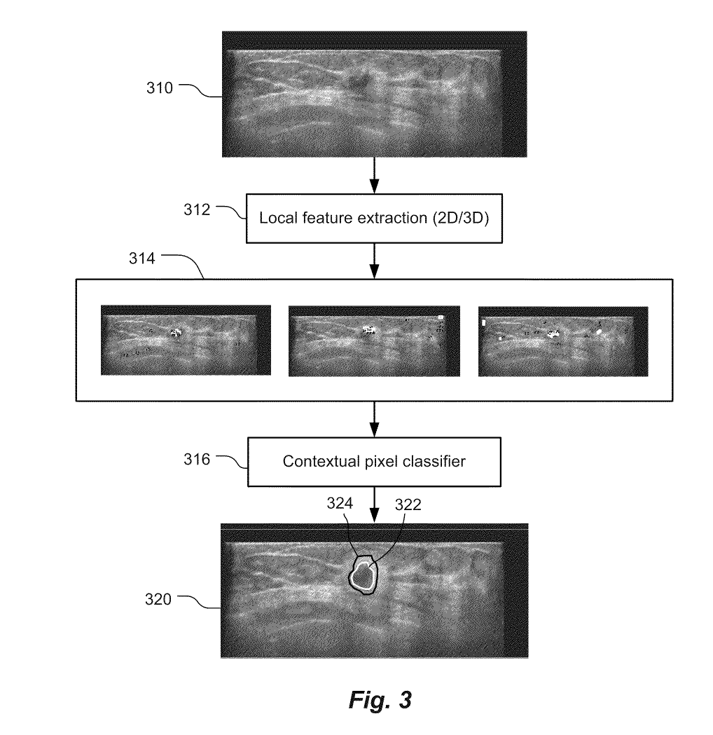

FIG. 3 is a flowchart showing combination of features at a voxel level using context, resulting in a likelihood of abnormality, according to some embodiments. Input image 310 is input to the local feature extraction 312 which corresponds to the modules 120, 122 and 124 as described with respect to FIG. 1. Examples of the cross sections highlighted according to the three modules is shown in 314 which correspond to the cross section examples shown in FIG. 2. The results of the modules are combined in the contextual voxel classifier 316, which corresponds to the step 126 of FIG. 1. The result is the likelihood map 320 which shows the highest values outlined in white such as region 322 and the next highest values outlined in black, such as region 324.

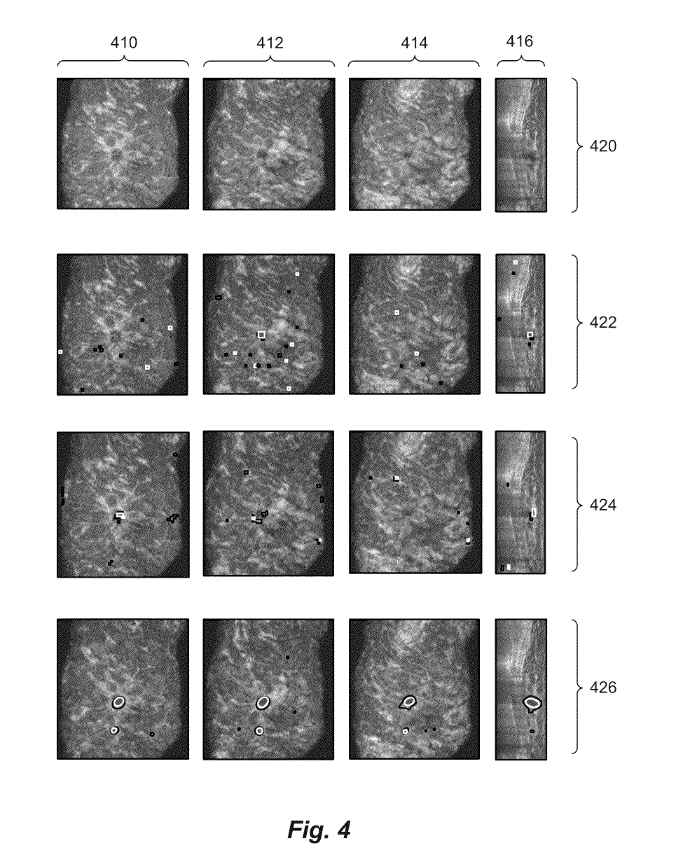

FIG. 4 is a matrix of coronal views and cross sections of a malignant lesion at three different depths, according to some embodiments. Depth increases from column 410 being coronal views shallowest (closest to the skin), column 412 being coronal views of medium depth, and column 414 being coronal views being the deepest (furthest from the skin). Column 416 are transversal plane views. Row 420 shows the original image. Row 422 shows an overlay of the results of gradient convergence module 120 (as described with respect to FIG. 1). Row 424 shows an overlay of the results of coronal spiculation module 124 (as described with respect to FIG. 1). Row 426 shows the overlay of lesion likelihood as a result of the contextual voxel classification step 128. In the rows 422, 424 and 426, the highest values (most likely to be malignant) is outlined in white, and the next highest values is outlined in black.

Further detail of the contextual voxel classification and candidate detection steps will now be provided, according to some embodiments. In step 128, selected voxels on a regular 3D grid of locations covering the breast tissue are classified using a feature vector that comprises information extracted by the feature extraction modules 126 at the location (x, y, z) of the voxel itself and its surroundings. The latter is essential because it has been observed that in 3D breast ultrasound imaging the central locations of lesions often do not coincide with focal points of spiculation patterns associated with the lesions. In particular, for example, it has been found that spiculation patterns in coronal planes are often are stronger in a region in the upper part of a lesion (closer to the skin) or even outside the lesion, as can be seen in FIGS. 2A-D. Therefore, a contextual voxel or pixel classification method 128 is designed that brings together information extracted in nearby locations. According to some embodiments the feature vector f(r) at a given location r=(x, y, z,)^{T} is augmented with the maximum of selected features in a neighborhood of r. For instance, the maximum of each of the spiculation features in a column centered at r and oriented in the z direction can be added to the feature vector. According to other embodiments, a contextual Markov Random Field can be defined to represent relations between features in a neighborhood of r. A feature vector can also be defined as the concatenation of feature vectors in a neighborhood of r.

According to some embodiments, to determine a set of candidate locations that are most representative of cancer, supervised learning is used. A set of training cases is used in which locations of relevant abnormalities. The training set includes both malignant and benign lesions (e.g. cysts and fibroadenoma). For training of classifiers, voxels and associated feature vectors in the center of annotated lesions are taken as abnormal patterns, while voxels sampled outside the lesions and/or in normal cases are used as normal samples. By supervised learning a classifier is trained to relate the input to a probability that an abnormality is present at a given location. Thus, the output of the contextual voxel classifier 128 is a volume representing likelihood of abnormality L(r). See, e.g. output view 320 in FIG. 3 and column 426 in FIG. 4. Referring again to FIG. 1, after smoothing in step 130, local maxima a determined in step 132. These are candidate locations used in further processing steps.

In step 134, candidate classification is carried out. As is common in most CAD systems a multi-stage model is employed. By thresholding, the most relevant candidate locations are selected and processed further. Typically, this processing includes a segmentation step in which the lesion boundary is localized. New features are computed, with the aim of representing relevant characteristics of the lesion by a numerical feature vector. Features for characterizing breast ultrasound lesions have been described in the literature for 2D handheld ultrasound and extension to 3D is straightforward. They include lesion contrast, margin contrast, margin sharpness, boundary smoothness, shadowing, width-to height ratio, and moments of the distribution of voxel values inside the lesion. Here a new set of features represented in coronal spiculation is added. These are computed from the distribution of coronal spiculation features computed in the candidate detection stage inside the lesion, e.g. mean variance and percentile values.

By supervised classification, the number of false positive candidates can be reduced, and/or the probability that a lesion is malignant or benign can be assessed. Three configurations of the CAD system are described below according to some embodiments, although other configurations are possible. The three described configurations are: false positive reduction; false positive reduction and subsequent lesion classification; and multi-class classification.

False positive reduction. According to some embodiments, false positives are defined as non-lesion locations. The detection system is trained with both benign and malignant lesions as target training patterns and it learns to distinguish those lesions from normal breast tissue. The task of deciding whether a lesion is more likely to be benign or malignant is left to the radiologist.

False positive reduction and subsequent lesion classification. According to some embodiments, the detection system is combined with a classification system trained to distinguish benign lesions from malignant lesions. The classification system is a feature-based system trained in the traditional way as a 2-class supervised classifier. The system is applied to regions surviving the false positive reduction step of the CAD system. In this way, each region detected by the CAD system has two numerical values assigned to it: one to indicate the probability that a lesion is present, and another to indicate the probability that the lesion is malignant.

Multi-class classification. According to some embodiments, non lesion locations form one class in a multi-class classification system. The system is trained to distinguish non-lesion locations, cancer, and benign lesions. The CAD system computes a likelihood value for each of the classes. It is noted that these likelihood values depend on prevalence and characteristics of the classes in the training set, which is dependent on the case sample and on the threshold applied in the candidate lesion detector. This has to be taken into account when information is displayed to the radiologist.

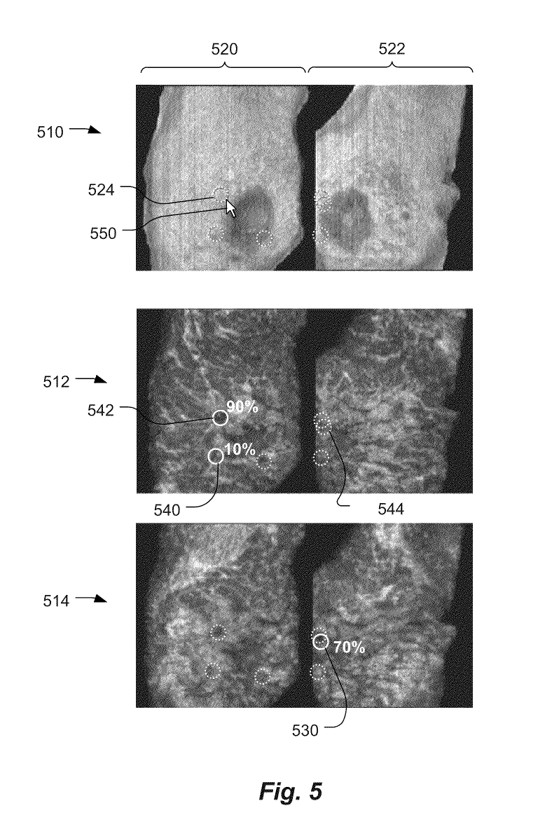

Users can use CAD marks to increase quality of their reading. By using CAD marks as guidance, image volumes may be more efficiently searched for abnormalities, without overlooking lesions. FIG. 5 illustrates methods of presenting CAD results to users, according to some embodiments. Column 522 shows lateral coronal views and column 520 shows medial coronal views. The woman in this case has an invasive ductal cancer. The images 510 shows the slice at the skin level. White dashed circles such as circle 524 are interactive CAD finding projections. By activating a mark, such a by selecting it with a pointer, the coronal view at the depth where the selected finding is located is shown. If depth of the displayed view corresponds with the location of the CAD finding the prompt is displayed in a solid white circle, such as circle 540.

The images 512 are the coronal views at the depth corresponding to the lesions marked by solid white circles 540 and 542. Where there are lesions that do not correspond with the slice depth, white dashed circles are shown for the CAD marks, such as mark 544. Images 514 show the coronal slices viewed a depth corresponding to a lesion as shown by the CAD mark 530 displayed in a solid white circle. According to some embodiments, colors are used in the display and green circles denote the slice depth does not correspond to the lesion depth and red circles are used when the view corresponds to the lesion depth.

According to some embodiments, a function is available that allows the user to move the display automatically to the slice in which CAD identified a suspicious region. This slice, or depth, can be determined by taking the maximum of the likelihood image, or the center of the segmentation. This function can be activated by clicking on the marked location with a mouse pointer, such as pointer 550. Optionally, the display can automatically synchronize the displayed slices, to the same depth in all displayed views. In this way, radiologists can more efficiently make comparisons between views, which is usually done at the same depth. In the case of FIG. 5, the views of column 522 (lateral coronal views) and column 520 (medial coronal views) are synchronized for each depth. The top row, images 510 show slices at the skin surface (both having a depth=0). Images 512 are slices both having a depth of the solid marked lesions 540 and 542. Images 514 are deeper slices, both at the depth of the lesion of CAD mark 530.

According to some embodiments, when activating a CAD mark, the likelihood of malignancy computed by the CAD system can be displayed. In images 512 for example, the computed likelihoods for the marks 540 and 542 are 10% and 90% respectively. For further details on such display techniques, see International Patent Application No. PCT/US2009/066020, which is incorporated herein by reference. According to some embodiments, if a benign/malignant or multi-class classification scheme is used, the display can include an indication that a lesion is malignant or benign.

According to some embodiments, a function is available that allows the user to move the display automatically to the slice in which CAD identified a suspicious region exists when viewing slices from the original scanning acquired images. For example, FIGS. 2A-D could be the taken from the original scanned images such as acquired in step 110 of FIG. 1. According to such embodiments, the original scanned 2D images can be displayed to the user in a cine fashion, which automatically stops or pauses when the image contains a CAD identified a suspicious region. Current users of hand held breast ultrasound, such as radiologists, may be more familiar and/or feel more comfortable with viewing original 2D acquired image. According to some embodiments, the display can also be interactive when displaying and automatically stopping at 2D images containing a CAD identified suspicious region. For example, the CAD identified suspicious region can be highlighted using solid and/or dashed circles such as shown in FIG. 5, and in response to a user's selection with a pointer, the system can interactively display information, such as likelihood of malignancy as shown in FIG. 5.

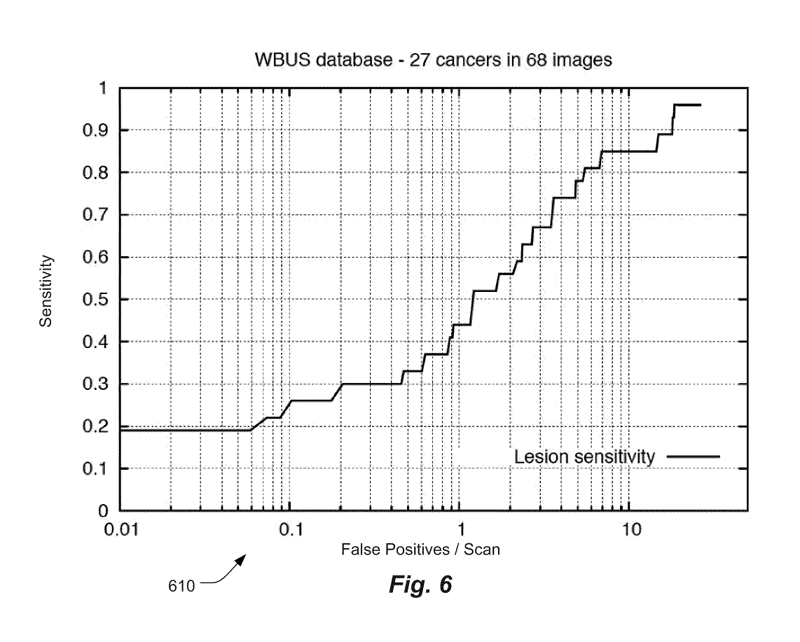

FIG. 6 is a plot showing free response operating characteristic (FROC) demonstrating detection performance of the candidate detection stage, according to some embodiments. Plot 610 shows detection sensitivity as a function of the number of false positives per 3D image volume. The plot 610 shows the result of applying the candidate detection method as described herein to a series of test and training cases.

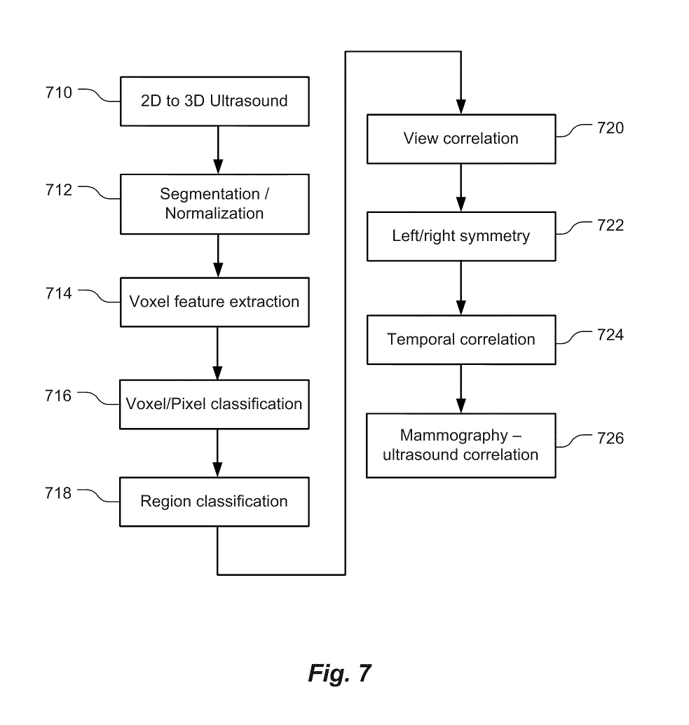

FIG. 7 is a flowchart showing steps in carrying out CAD analysis of ultrasound breast images, according to some embodiments. In step 710 a 3D ultrasound volume is input, artifacts are removed and resampling for coronal view reconstruction is carried out. This step corresponds to steps 112 and 114 in FIG. 1. In step 712, the image is segmented to identify the breast tissue, and the image is normalized. This step corresponds to steps 116 and 118 in FIG. 1. In step 714, each voxel is analyzed using modules for gradient convergence, spiculation in coronal planes and local contrast. This step corresponds to using modules 126 in FIG. 1. In step 716, each pixel or voxel is classified, which corresponds to step 128 in FIG. 1. In step 718, groups of voxels are segmented having similar properties and classified according to characteristics of the region such as size, shape, lesion contrast, margin contrast, margin sharpness, boundary smoothness, shadowing, width-to height ratio, moments of the distribution of voxel values inside the lesion, and coronal spiculation. This step corresponds to step 134 in FIG. 1.

Up until now, the processing steps described in FIG. 7 relate to image information from a single view of a single breast. In steps 720, 722, 724, and 726 the information is compared to other views, other breasts (i.e. left vs. right), scans at other times, and images from other modalities such as mammography. According to some embodiments, the steps 720, 722, 724 and 726 are used to adjust the likelihood of malignancy.

In step 720, correlation between different views is carried out. Ordinarily, more than one ultrasound scan is used to cover a breast. If a lesion occurs in an overlap area, then correlation between different views of the same breast can be carried out. In step 722, left versus right breast symmetry check is carried out which can identify false positives due. In step 724, a temporal comparison is carried out, for example between ultrasound scans of the same breast taken at different times, such as separated by one or more years. In step 726, a comparison with other modalities such as mammography is carried out. According to some embodiments, one or more of the comparison steps 720, 722, 724 and 726 are not carried out, are performed in a different order than shown in FIG. 7, and/or performed in parallel with each other.

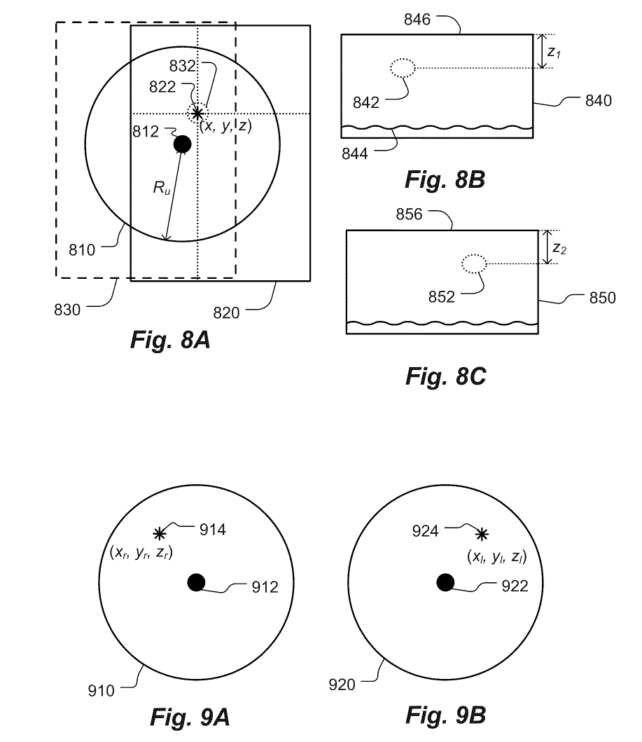

FIGS. 8A-C show further detail of view correlation procedures, according to some embodiments. In FIG. 8A, a first scan, shown in coronal view 820, is made of breast 810 having a nipple 812. From the first scan, a region of interest is identified which is shown by the mark 822 on coronal view 820. The region of interest is identified, for example, using the techniques discussed with respect to FIG. 1. The position of the nipple 812 in the first scan is determined either manually by an operator, or alternatively the nipple position can be automatically determined as is known in the art. The position of the region of interest relative to the nipple using x, y, z coordinates can therefore be determined. The x₁ and y₁ position of the region marked 822 in the first scan can be shown in the coronal view 820 of FIG. 8A. FIG. 8B is a transversal slice that shows the depth z₁ of the region of interest shown by the spot 842 as measured from the skin surface 846. Chest wall 844 is also shown. In the second scan, a region of interest having a location relative to the nipple of x₂, y₂ and z₂. In FIG. 8A, the coronal view 830 is shown for the second scan of the breast 810, with the corresponding region of interest 832 marked by the dashed circle. The position x₂ and y₂ can be shown in the coronal view. The depth z₂ is shown in FIG. 8C as the distance between skin surface 856 and region of interest marked by dashed circle 852 in transversal view 850. According to some embodiments, a threshold distance condition can be applied for the maximum distance between the regions of interest in first and second scans:

\sqrt{Δx²+Δy²+Δz²}≦Maximum Distance. (10)

Then the correlation between regions of interest in the first and second scans can be calculated as:

error=\sqrt{k₁Δfeature_{—}1+k₂Δfeature_{—}2+k₃Δfeature_{—}3} (11)

where k₁, k₂ and k₃ . . . are weighting factors for each of the features of the regions of interest. Examples of feature_{—}1, feature_{—}2, etc are features such as size, shape, coronal spiculation, contrast, etc. According to some embodiments, the values for the threshold for maximum distance and/or the weighting factors k₁, k₂ and k₃ can be determined using a free response operating characteristic (FROC) curve, where the values are adjusted so as to yield the highest sensitivity for given false positive rates per volume.

FIGS. 9A-B show further detail of left and right symmetry checking, according to some embodiments. In FIG. 9A, is a coronal view of a scan of a patent's right breast 910 and FIG. 9B is a coronal view of a scan of a patient's left breast 920. The region marked 914 on the right breast is shown in coronal view 910 having a position relative to the nipple 912 of xᵣ, yᵣ and Zᵣ. Similarly, a region marked 924 on the left breast is shown in coronal view 920 having a position relative to the nipple 922 of xₗ, yₗ and zₗ. The same or similar threshold as shown in equation (10) and the error evaluation of equation (11) can be used. However, as symmetry about the sagittal plane is being checked, yₗ=−yᵣ, and greater correlation indicates decreased likelihood of malignancy.

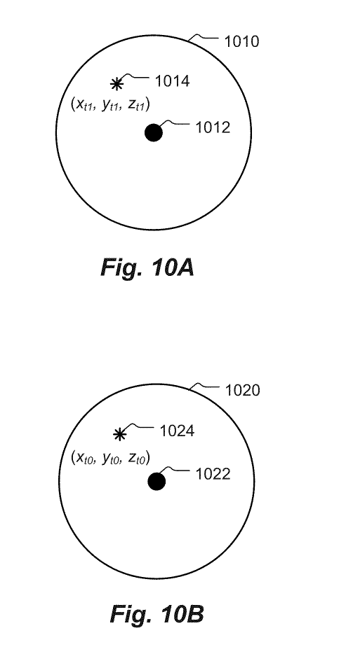

FIGS. 10A-B show further detail of temporal correlation procedures, according to some embodiments. FIG. 10A, is a coronal view of a scan of a patient's breast 1010 at one time (t₁). FIG. 10B is a coronal view of a scan of a patient's breast 1020 at an earlier time (t₀). Ordinarily, screening scans are performed at regular intervals, such as one year to two years, which would be the difference between t₀ and t₁. The region marked 1014 on the later scan of the breast is shown in coronal view 1010 having a position relative to the nipple 1012 of Xₜ₁, yₜ₂ and zₜ₂. Similarly, a region marked 1024 on the earlier scan of the breast is shown in coronal view 1020 having a position relative to the nipple 1022 of xₜ₀, yₜ₀ and zₜ₀. The same or similar threshold as shown in equation (10) and the error evaluation of equation (11) can be used. However, for temporal comparisons, a finding smaller differences (or greater similarity) between two scans at different times tends to decrease the likelihood of malignancy.

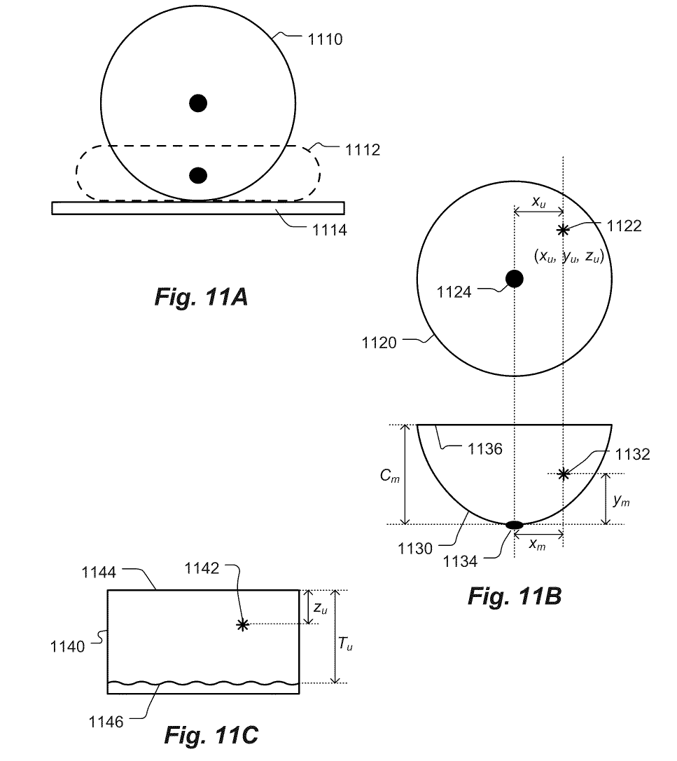

FIGS. 11A-C show further detail of correlation procedures between ultrasound images and cranio-caudal (CC) view of a mammographic image, according to some embodiments. FIG. 11A illustrates breast tissue as compressed for a CC mammography view. The uncompressed breast tissue 1110 is compressed as shown by outline 1112, against a platen 1114. FIG. 11B shows a coronal view 1120 of an ultrasound scan having a region of interest 1122, as well as a CC view 1130 from a mammography scan having a region of interest 1132. The position of region 1122 relative to the nipple 1124 in the ultrasound image can be determined to be xᵤ, yᵤ and zᵤ, as has been explained previously. In the CC mammography image 1130, the distance xₘ relative to the nipple 1134 can be determined and is:

xₘ=xᵤ (12)

provided the image scales are normalized. The distance yₘ can be estimated from the ratio of the depth of the corresponding lesion in a transverse or sagittal slice of the ultrasound scan. FIG. 11C shows a transverse slice 1140 of and ultrasound scan where the region of interest 1142 is at depth zᵤ form the skin surface 1144. The total thickness of the breast tissue in slice 1140 from skin surface 1144 and the chest wall 1146 is denoted as Tᵤ. The distance yₘ in the CC mammography image is therefore:

yₘ=Cₘ(zᵤ/Tᵤ) (13)

where the Cₘ is the total distance from the nipple 1134 to the chest wall 1136 in FIG. 11B.

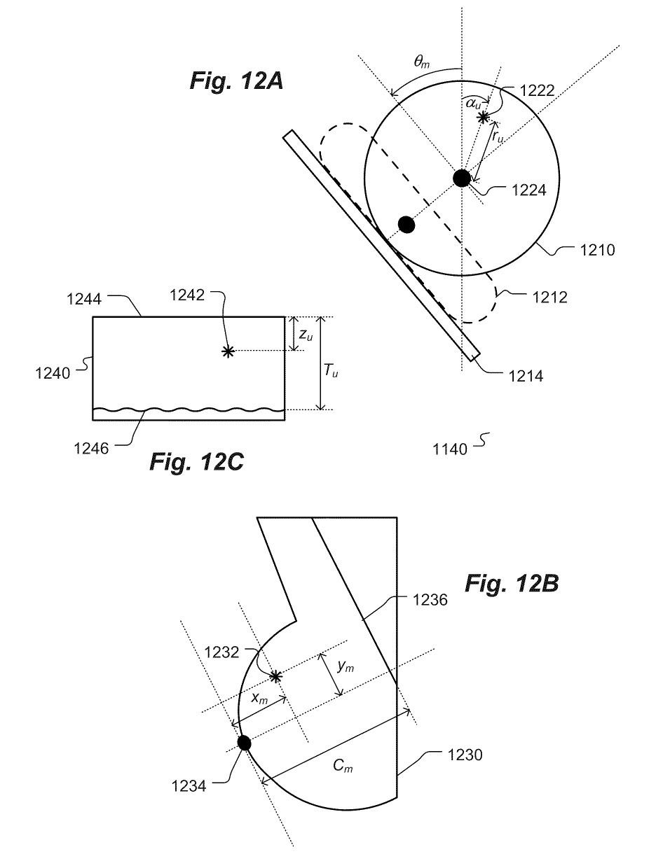

FIGS. 12A-C show further detail of correlation procedures between ultrasound images and mediolateral oblique (MLO) view of a mammographic image, according to some embodiments. FIG. 12A illustrates breast tissue as compressed for a MLO mammography view. The uncompressed breast tissue 1210 is compressed as shown by outline 1212, against a platen 1214. 1210 also represents a coronal view of an ultrasound scan having a region of interest 1222. FIG. 12B is an MLO view 1230 from a mammography scan having a region of interest 1232. The position of region 1222 relative to the nipple 1224 in the ultrasound image can be determined to be xᵤ, yᵤ and zᵤ, as has been explained previously. The distance xₘ can be estimated from the ratio of the depth of the corresponding lesion in a transverse or sagittal slice of the ultrasound scan. FIG. 12C shows a transverse slice 1240 of and ultrasound scan where the region of interest 1242 is at depth zᵤ form the skin surface 1244. The total thickness of the breast tissue in slice 1240 from skin surface 1244 and the chest wall 1246 is denoted as Tᵤ. The distance xₘ in the MLO mammography image is therefore:

xₘ=Cₘ(zᵤ/Tᵤ) (14)

where the Cₘ is the total distance from the nipple 1234 to the chest wall 1236. The distance yₘ in the MLO mammography image can be related to position of the region of interest 1222 in relation to the nipple 1224 and the angles αᵤ, which is the angular position of the region 1222, and the oblique imaging angle θₘ which can be determined, for example from the mammography image (DICOM) (Digital Imaging and Communications in Medicine standard) header. The distance yₘ in the MLO mammography image can be estimated as:

yₘ=rᵤ cos(αᵤ−θₘ) (15)

where rᵤ is the radial distance of the region 1222 from the nipple 1224 in the ultrasound coronal view 1210, and can be related to xᵤ and yᵤ by rᵤ=\sqrt{xᵤ²+yᵤ²}. Once the equivalent coordinates in the mammography view (CC and MLO) are found as described herein, the same or similar threshold as shown in equation (10) and the error evaluation of equation (11) can be used in correlating regions of interest ultrasound and mammographic images.

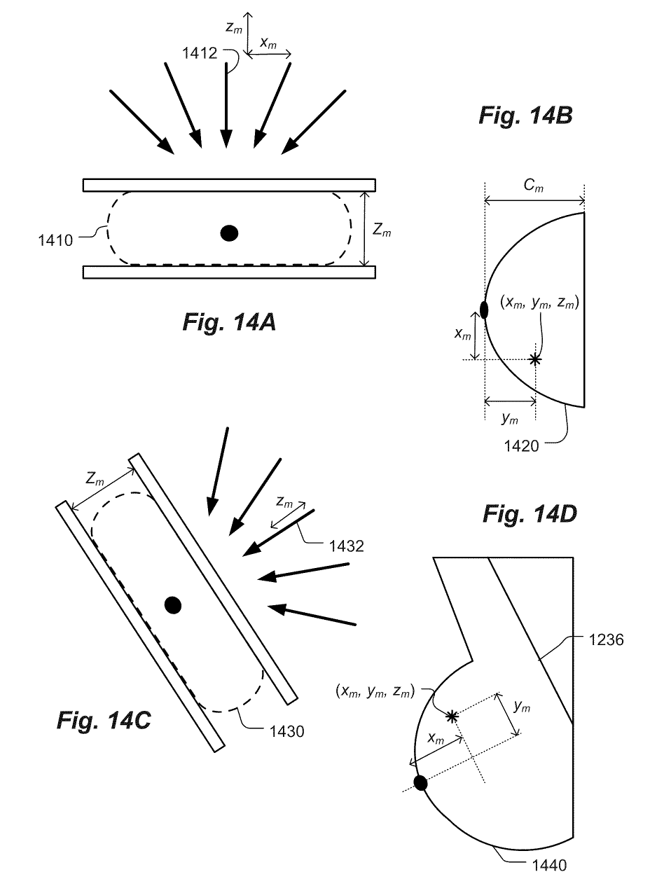

According to some embodiments, the correlation of CAD results between ultrasound and mammographic images is applied to x-ray tomographic breast images. For example, in x-ray tomosynthesis mammography, the breast tissue is compressed as in the standard CC and MLO views, and multiple x-ray images are taken a different angles. A computer process then synthesizes the 3D mammographic image of the breast. FIGS. 14A-D show x-ray tomosynthesis imaging displayed views, according to some embodiments. FIG. 14A illustrates breast tissue 1410 being compressed and imaged for x-ray tomosynthesis imaging of a CC view. The tissue is imaged at multiple angles centered around the direction 1412. FIG. 14B is an example of a CC view 1420 of a tomosynthesis mammagraphic image. Using the coordinates shown, xₘ and yₘ can be related to ultrasound images of the same breast using the equations (12) and (13) as described above. The distance zₘ, which was not available in standard mammography, is the distance perpendicular to the CC view 1420, and can be related to ultrasound images using the simple relationship:

$${z}_{m} = {Z}_{m} ( \frac{{y}_{u}}{2 {R}_{u}} ) \qquad ( 16 )$$

where Zₘ is the total thickness of the tomosynthesis image (see FIGS. 14A and 14C), which can be retrieved from the DICOM header or directly measured from the image volume, and Rᵤ is the radius of the breast measured from the coronal ultrasound image, an example of which is shown in FIG. 8A. If the ultrasound image or images result from multiple scans, Rᵤ is preferably measured in a region of the image that is common to both scans 820 and 830 as shown in FIG. 8A.

FIG. 14C illustrates breast tissue 1430 being compressed and imaged for x-ray tomosynthesis imaging of a MLO view. The tissue is imaged at multiple angles centered around the direction 1432. FIG. 14D is an example of a MLO view 1440 of a tomosynthesis mammagraphic image. Using the coordinates shown, xₘ and yₘ can be related to ultrasound images of the same breast using the equations (14) and (15) as described above. The distance zₘ, which was not available in standard mammography, is the distance perpendicular to the MLO view 1440, and can be related to ultrasound images using the relationship:

$${z}_{m} = {Z}_{m} ( \frac{{r}_{u} sin ( {α}_{u} - {θ}_{m} )}{2 {R}_{u}} ) \qquad ( 17 )$$

where rᵤ and αᵤ and θₘ are defined as described above with respect to FIG. 12A.

The described techniques for correlating locations in mammography images and ultrasound images are more robust than those such as discussed in the '602 patent which are applicable only in cases where the breast tissue is compressed, in both ultrasound and mammography, in directions perpendicular to an axis that is perpendicular to the chest wall and passes through the nipple. In contrast, the techniques disclosed according to some embodiments herein, are applicable to cases where the ultrasound image is made with a breast compressed in a direction perpendicular to the chest wall (i.e. the breast tissue is compressed directly towards the chest wall), and the mammography image compression is according to a standard view (e.g. CC or MLO).

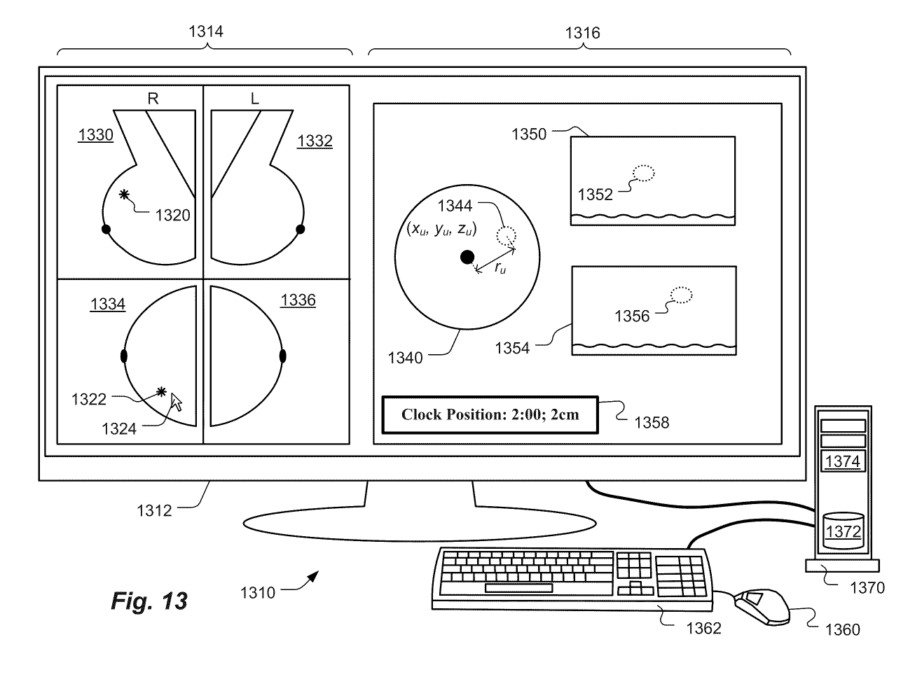

According to some embodiments, the techniques described here for relating positions in ultrasound images and mammography images are used to provide a useful user interface for users such as radiologists who are reading, reviewing or otherwise analyzing the images. FIG. 13 shows a user interface which relates positions in mammographic and ultrasound images, according to some embodiments. The user interface 1310 includes a display 1312, input devices such as keyboard 1362 and mouse 1360, and a processing system 1370. According to some embodiments, other user input methods such as touch sensitive screen screens can be used.

Processing system 1370 can be a suitable personal computer or a workstation that includes one or more processing units 1342, input/output devices such as CD and/or DVD drives, internal storage 1372 such as RAM, PROM, EPROM, and magnetic type storage media such as one or more hard disks for storing the medical images and related databases and other information, as well as graphics processors suitable to power the graphics being displayed on display 1312.

The display 1312 is shown displaying two areas. Mammographic display area 1314 is similar to a mammography workstation for viewing digital mammography images. Ultrasound display area 1316 is similar to an ultrasound image workstation for viewing 3D ultrasound breast images. Mammographic display area 1314 is shown displaying four mammographic images, namely right MLO view 1330, left MLO view 1332, right CC view 1334, and left CC view 1336. Shown on right MLO view 1330 is a region of interest 1320, and on right CC view 1336 is region of interest 1322.

According to some embodiments, the user selects both regions 1320 and 1322 in mammographic display area 1314, for example, by clicking with mouse pointer 1324. By selecting both regions 1320 and 1322, the user is indicating to the system that the user believes the two regions 1320 and 1322 are the same suspicious lesion. In response to the user selection of the two regions 1320 and 1322, the system estimates the corresponding location in the ultrasound image and automatically displays suitable ultrasound images to the user. In the example shown, the system displays a coronal view 1340 of an ultrasound scan of the patient's right breast, at the depth associated with the suspected lesion, as well as a mark indicator, such as dashed circle 1344 at a position on the coronal view 1340. Also displayed are transversal view 1350 and sagittal view 1354, both at locations corresponding to the estimated location of the user selected lesion. The mark indicators 1352 and 1356 indicate the estimated locations of the lesion in views 1350 and 1354 respectively. According to some embodiments, the system uses relationships such as shown in equations (12), (13), (14) and (15) to relate the user selected locations on the mammographic images to the displayed estimated locations on the ultrasound images.

According to some embodiments, the user interface system 1310 can operate in an inverse fashion as described above. Namely, the user selects a location on any of the ultrasound views, and in response the system displays the estimated corresponding locations on the mammographic images. For example, the user selects a location on the coronal image 1340. In response, the system estimates and automatically highlights the corresponding locations on the CC and MLO views of the mammographic image. Note that since the 3D coordinates can be determined from a single selection on one of the ultrasound images, the system can estimate the mammographic locations in response to making a selection on only one ultrasound image view. As described above, the system can use relationships such as shown in equations (12), (13), (14) and (15) to relate the user selected location on the ultrasound image to the corresponding estimated locations on the mammographic images.

According to some embodiments the user interface system as described with respect to FIG. 13 is applied to three-dimensional mammographic images such as tomosynthesis mammography images.

According to some embodiments, in response to the user selecting a location on either display area 1314 or 1316 as described, the system estimates and displays a clock position and radial distance from the nipple. Such estimation and display to the user can be helpful to the user in describing the location of the suspicious lesion to others. On display 1312, the clock position and radial distance is shown in window 1358.

Whereas many alterations and modifications of the present disclosure will no doubt become apparent to a person of ordinary skill in the art after having read the foregoing description, it is to be understood that the particular embodiments shown and described by way of illustration are in no way intended to be considered limiting. Further, the disclosure has been described with reference to particular preferred embodiments, but variations within the spirit and scope of the disclosure will occur to those skilled in the art. It is noted that the foregoing examples have been provided merely for the purpose of explanation and are in no way to be construed as limiting of the present disclosure. While the present disclosure has been described with reference to exemplary embodiments, it is understood that the words, which have been used herein, are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method of analyzing ultrasound images of breast tissue comprising:
receiving a digitized ultrasound image of the breast tissue, the image resulting from ultrasound scanning while the breast tissue is compressed in a compression direction;
processing the image so as to generate one or more view slices that are approximately perpendicular to the compression direction; and
processing the image using one or more computer aided detection algorithms so as to identify locations of one or more regions of interest within the image based at least in part on identified areas of spiculation in portions of one or more of the view slices.

2. A method according to claim 1 wherein the compression direction is from the nipple toward the chest wall, and the view slices coronal view slices being approximately parallel to skin surface of the breast tissue.

3. A method according to claim 2 further comprising processing the image so as to generate one or more views slices that are approximately perpendicular to the skin surface of the breast tissue.

4. A method according to claim 3 wherein the one or more views slices that are approximately perpendicular to the skin surface of the breast tissue are approximately parallel to a transverse plane of the patient.

5. A method according to claim 3 wherein the one or more views slices that are approximately perpendicular to the skin surface of the breast tissue are approximately parallel to a sagittal plane of the patient.

6. A method according to claim 3 wherein the one or more regions of interest are identified based in part on one or more identified features in one or more of the views slices that are approximately perpendicular to the skin surface of the breast tissue.

7. A method according to claim 6 wherein the an identified area of spiculation in portions of the image in one or more of the coronal view slices is closer to the skin surface than a corresponding identified feature in one or more of the views slices that are approximately perpendicular to the skin surface of the breast tissue.

8. A method according to claim 6 wherein the one or more identified features in one or more of the views slices that are approximately perpendicular to the skin surface of the breast tissue, are identified based on gradient convergence.

9. A method according to claim 6 wherein the one or more identified features in one or more of the views slices that are approximately perpendicular to the skin surface of the breast tissue, are identified based on local contrast.

10. A method according to claim 1 wherein the one or more regions of interest are classified according to one or more features selected from the group consisting of: lesion shape, lesion size, lesion contrast, margin contrast, margin sharpness, boundary smoothness, shadowing, width-to height ratio, and moments of the distribution of voxel values inside the lesion.

11. A method according to claim 1 further comprising displaying to a user one or more of the identified regions of interest.

12. A method according to claim 1 further comprising estimating a likelihood of malignancy for each of the regions of interest.

13. A method according to claim 12 further comprising displaying to a user one or more of the identified regions of interest and the estimated likelihood of malignancy associated with each displayed region of interest.

14. A method according to claim 1 wherein the method is used primarily for screening purposes.

15. A method according to claim 1 wherein the method is used primarily for diagnostic purposes.

16. A system for analyzing ultrasound images of breast tissue comprising a processing system adapted and programmed to receive a digitized ultrasound image of the breast tissue; process the image so as to generate one or more coronal view slices that are approximately parallel to a skin surface of the breast tissue; and to process the image using one or more computer aided detection algorithms so as to identify one or more regions of interest within the image based at least in part on identified areas of spiculation in portions of the image in one or more of the coronal view slices.

17. A system according to claim 16 further comprising a display in communication with the processing system and adapted to display to the user one or more of the identified regions of interest.

18. A system according to claim 16 wherein the processing system is further adapted and programmed to estimate a likelihood of malignancy for each of the regions of interest.

19. A system according to claim 18 further comprising a display in communication with the processing system and adapted to display to the user one or more of the identified regions of interest and the estimated likelihood of malignancy associated with each displayed region of interest.

20. A method of analyzing ultrasound images of breast tissue of a patient comprising:
receiving a first digitized ultrasound image of breast tissue of the patient;
processing the first digitized image using one or more computer aided detection algorithms thereby generating a region of interest in the first image;
receiving a second digitized ultrasound image of breast tissue of the patient;
processing the second ultrasound image using one or more computer aided detection algorithms thereby generating a region of interest in the second image; and
evaluating a likelihood of malignancy based at least in part on an estimated distance between a location of the region of interest in the first image and a location the region of interest in the second image.

21. A method according to claim 20 wherein the first and second digitized image are three dimensional digitized ultrasound images.

22. A method according to claim 20 wherein the second digitized image is a three dimensional ultrasound image of tissue of the same breast of the patient as in the first image.

23. A method according to claim 22 wherein the first image results from a first ultrasound scan and the second digital image results from a second ultrasound scan, and wherein the first and second scans are made less than 24 hours apart.

24. A method according to claim 23 wherein the processing includes identifying one or more characteristics in each of the regions of interest, and wherein greater similarities in said characteristics between the regions of interest tend to increase the likelihood of malignancy.

25. A method according to claim 22 wherein the first image results from a first ultrasound scan and the second digital image results from a second ultrasound scan, and wherein the first and second scans are greater than 6 months apart.

26. A method according to claim 25 wherein the processing includes identifying one or more characteristics in each of the regions of interest, and wherein greater similarities in said characteristics between the regions of interest tend to decrease the likelihood of malignancy.

27. A method according to claim 20 wherein the second digitized image is a three dimensional ultrasound image of tissue of a different breast of the patient as in the first image.

28. A system for analyzing ultrasound images of breast tissue of a patient comprising a processing system adapted and programmed to process a first digitized ultrasound image of breast tissue of the patient using one or more computer aided detection algorithms so as to generate a region of interest in the first image, to process a second digitized ultrasound image of breast tissue of the patient using one or more computer aided detection algorithms so as to generate a region of interest in the second image; and to estimate a likelihood of malignancy based at least in part on an estimated distance between a location of the region of interest in the first image and a location the region of interest in the second image.

29. A system according to claim 28 wherein the first image results from a first ultrasound scan and the second digital image results from a second ultrasound scan, and wherein the first and second scans are made less than 24 hours apart.

30. A system according to claim 28 wherein the first image results from a first ultrasound scan and the second digital image results from a second ultrasound scan, and wherein the first and second scans are greater than 6 months apart.

31. A method of analyzing digital images of breast tissue of a patient comprising:
receiving a digitized ultrasound image of breast tissue of the patient resulting from ultrasound scanning in which the breast tissue is compressed in a direction towards a chest wall of the patient;
processing the digitized ultrasound image using one or more computer aided detection algorithms thereby generating a region of interest in the ultrasound image;
receiving a digitized mammographic image of breast tissue of the patient, wherein the breast tissue is the same breast of the patient as in the ultrasound image;
processing the mammographic image using one or more computer aided detection algorithms thereby generating a region of interest in the mammographic image; and
evaluating a likelihood of malignancy based at least in part on an estimated distance between a location of the region of interest in the ultrasound image and a location the region of interest in the mammographic image.

32. A method according to claim 31 wherein the mammographic image is a cranio-caudal view image.

33. A method according to claim 31 wherein the mammographic image is a mediolateral oblique view image.

34. A method according to claim 31 wherein the mammographic image is a tomographic mammographic image.

35. A system for analyzing digitized images of breast tissue of a patient comprising a processing system adapted and programmed to process a digitized three-dimensional ultrasound image of breast tissue of the patient resulting from ultrasound scanning in which the breast tissue is compressed in a direction towards a chest wall of the patient, using one or more computer aided detection algorithms so as to generate a region of interest in the ultrasound image, to process a digitized mammographic image of breast tissue of the patient using one or more computer aided detection algorithms so as to generate a region of interest in the mammographic image; and to estimate a likelihood of malignancy based at least in part on an estimated distance between a location of the region of interest in the ultrasound image and a location the region of interest in the mammographic image.

36. A method of interactively displaying ultrasound and mammographic images of a breast tissue to a user comprising:
receiving one or more digitized mammographic images of the breast tissue;
receiving a digitized three-dimensional ultrasound image of the breast tissue resulting from ultrasound scanning in which the breast tissue is compressed in a direction towards a chest wall of the patient;
receiving from the user a location or locations on the one or more mammographic images of a user identified region of interest in the breast tissue;
estimating one or more locations on the ultrasound image that correspond to the location or locations on the one or more mammographic images of the user identified region of interest; and
displaying to the user, portions of the digitized ultrasound image indicating the one or more estimated locations on the ultrasound image that correspond to the location of the user identified region of interest.

37. A method according to claim 36 wherein the one or more digitized mammographic images includes a cranio-caudal view and a mediolateral oblique view, and a the user identified region of interest in the breast tissue is identified by the user by at least one location on the cranio-caudal view and at least one location on the mediolateral oblique view.

38. A method according to claim 36 wherein a portion of the digitized ultrasound image displayed to a user includes displaying to the user a coronal view slice that is approximately parallel to a skin surface of the breast tissue.

39. A method according to claim 36 wherein a portion of the digitized ultrasound image displayed to a user includes displaying to the user a view slice that is approximately perpendicular to a skin surface of the breast tissue.

40. A method according to claim 36 further comprising processing the ultrasound image using one or more computer aided detection algorithms thereby generating one or more CAD regions of interest.

41. A method according to claim 36 further comprising displaying to a user an estimated position of the user identified region of interest relative to an identified nipple on the breast tissue using a clock position and distance from the nipple.

42. A method according to claim 36 wherein the one or more mammographic images includes is a three-dimensional mammographic image.

43. A system for interactively displaying medical ultrasound and mammographic images of a breast tissue to a user comprising:
a processing system adapted and programmed to estimate one or more locations on a three-dimensional digitized ultrasound image of the breast tissue resulting from ultrasound scanning in which the breast tissue is compressed in a direction towards a chest wall of the patient that correspond to a location or locations on one or more mammographic images of a user identified region of interest provided by the user; and
a display in communication with the processing system and adapted to display to the user, portions of the digitized ultrasound image indicating the one or more estimated locations on the ultrasound image that correspond to the location of the user identified region of interest.

44. A system according to claim 43 wherein the processing system is further adapted and programmed to process ultrasound image using one or more computer aided detection algorithms thereby generating one or more CAD regions of interest.

45. A method of interactively displaying ultrasound and mammographic images of a breast tissue to a user comprising:
receiving a one or more digitized mammographic images of the breast tissue;
receiving a digitized three-dimensional ultrasound image of the breast tissue resulting from ultrasound scanning in which the breast tissue is compressed in a direction towards a chest wall of the patient;
receiving from the user a location on the ultrasound image of a user identified region of interest;
estimating one or more locations on the mammographic image that correspond to the location on the ultrasound image of the user identified region of interest; and
displaying to the user, at least portions of the one or more digitized mammographic images to a user indicating the one or more estimated locations on the one or more mammographic images that correspond to the location of the user identified region of interest.

46. A method according to claim 45 wherein the one or more digitized mammographic images includes a cranio-caudal view and a mediolateral oblique view, and a the system is adapted to receive the user identified region of interest in the breast tissue from the user by accepting from the user at least one location on the cranio-caudal view and at least one location on the mediolateral oblique view.

47. A method according to claim 45 further comprising processing the ultrasound image and/or the one or more mammographic images using one or more computer aided detection algorithms thereby generating one or more CAD regions of interest.

48. A method according to claim 45 further comprising displaying to a user an estimated position of the user identified region of interest relative to an identified nipple on the breast tissue using a clock position and distance from the nipple.

49. A method according to claim 45 wherein the one or more mammographic images includes is a three-dimensional mammographic image.

50. A system for interactively displaying ultrasound and mammographic images of a breast tissue to a user comprising:
a processing system adapted and programmed to estimate one or more locations on one or more digitized mammographic images of the breast tissue that correspond to a location or locations on a digitized three-dimensional ultrasound image of the breast tissue resulting from ultrasound scanning in which the breast tissue is compressed in a direction towards a chest wall of the patient of a user identified region of interest provided by the user; and
a display in communication with the processing system and adapted to display to the user, portions of the one or more digitized mammographic images indicating the one or more estimated locations on the one or more digitized mammographic images that correspond to the location of the user identified region of interest.

51. A system according to claim 50 wherein the processing system is further adapted and programmed to process the ultrasound image and/or the one or more mammographic images using one or more computer aided detection algorithms thereby generating one or more CAD regions of interest.

52. A method of interactively displaying computer aided detection results of ultrasound images to a user comprising:
receiving a digitized ultrasound image of breast tissue;
processing the image using one or more computer aided detection algorithms thereby generating one or more regions of interest;
displaying the digitized image to a user; and
displaying to the user one or more marks tending to indicate location on the tissue of at least one of the one or more regions of interest, and information relating to an estimated likelihood of malignancy for the at least one of the one or more regions of interest.

53. A method according to claim 52 wherein the information relating to the estimated likelihood includes an indication of a percentage of the estimated likelihood of malignancy.

54. A method according to claim 52 wherein the information relating to the estimated likelihood includes a color that is related to a percentage range of the estimated likelihood of malignancy.

55. A system for interactively displaying computer aided detection results of medical ultrasound images to a user comprising:
a processing system configured and programmed to receive a digitized ultrasound image of breast tissue and process the image using one or more computer aided detection algorithms thereby generating one or more regions of interest; and
a computerized display that displays to a user the digitized image, one or more marks tending to indicate location on the tissue of at least one of the one or more regions of interest, and information relating to an estimated likelihood of malignancy for the user identified regions of interest.

56. A system according to claim 55 wherein the information relating to the estimated likelihood includes an indication of a percentage of the estimated likelihood of malignancy.

57. A method of interactively displaying computer aided detection results of ultrasound images to a user comprising:
receiving a digitized ultrasound image data of breast tissue including a plurality of two-dimensional scan images;
processing the image data using one or more computer aided detection algorithms thereby generating one or more regions of interest; and
automatically displaying one or more of the two-dimensional scan images to a user that include at least one of the regions of interest.

58. A method according to claim 57 further comprising indicating to the user one or more marks tending to indicate location on the tissue of at least one of the regions of interest in at least one of the automatically displayed two-dimensional scan images.

59. A method according to claim 58 further comprising displaying information to the user relating to an estimated likelihood of malignancy for the at least one of the one or more regions of interest.

60. A method according to claim 57 further comprising interactively displaying information to the user relating to the at least one region of interest included in the displayed one or more two-dimensional scan images.

61. A system for interactively displaying computer aided detection results of medical ultrasound images to a user comprising:
a processing system configured and programmed to receive a digitized ultrasound image data of breast tissue including a plurality of two-dimensional scan images, and to process the image using one or more computer aided detection algorithms thereby generating one or more regions of interest; and
a computerized display that displays to a user one or more of the two-dimensional scan images that include at least one of the regions of interest.

62. A system according to claim 61 wherein the computerized display interactively displays information to the user relating to the at least one region of interest included in the displayed one or more two-dimensional scan images.

63. A system according to claim 62 wherein the interactively displayed information relates to an estimated likelihood of malignancy for the at least one of the one or more regions of interest.
